(19) United States
(12) Patent Application Publication
(10) Pub. No.: US 2020/0024982 A1
(43) Pub. Date: Jan. 23, 2020

(54) BOUNDARY LAYER INGESTING FAN

(71) Applicant: United Technologies Corporation, Farmington, CT (US)

(72) Inventor: Steven H. Zysman, Amston, CT (US)

(21) Appl. No.: 16/038,320

(22) Filed: Jul. 18, 2018

(51) Int. Cl. F01D 7/02; F01D 1/30; B64C 11/06; F02K 3/06

(52) U.S. Cl. CPC F01D 7/02; F01D 1/30; B64D 27/14; F02K 3/06; B64C 11/06

(57) ABSTRACT

A fan assembly for gas turbine engine according to an exemplary embodiment of this disclosure includes, among other possible things, a plurality of fan blades rotatable about a fan rotation axis, each of the plurality of fan blades movable about an axis transverse to the fan rotation axis, a fan nacelle partially surrounding the plurality of fan blades, and a pitch mechanism coupled to the plurality of blades that changes an angle of pitch for each of the plurality of blades corresponding to a circumferential position of the fan blade about the fan rotation axis.

### BACKGROUND

Conventional aircraft architecture includes wing mounted gas turbine engines. Alternate aircraft architectures mount the gas turbine engines atop the fuselage or on opposite sides of the aircraft fuselage adjacent to a surface. Accordingly, a portion of an engine fan may ingest portions of a boundary layer of airflow while other portions of the fan spaced apart from the aircraft surface may not encounter boundary layer flow. Differences in airflow characteristics across different parts of the fan can impact fan efficiency.

### SUMMARY

A fan assembly for gas turbine engine according to an exemplary embodiment of this disclosure includes, among other possible things, a plurality of fan blades rotatable about a fan rotation axis, each of the plurality of fan blades movable about an axis transverse to the fan rotation axis, a fan nacelle partially surrounding the plurality of fan blades, and a pitch mechanism coupled to the plurality of blades that changes an angle of pitch for each of the plurality of blades corresponding to a circumferential position of the fan blade about the fan rotation axis.

In a further embodiment of the foregoing gas turbine engine, the pitch mechanism changes an angle of pitch automatically for each of the plurality of fan blades at the corresponding circumferential position.

In a further embodiment of any of the foregoing gas turbine engines, an angle of pitch for at least two of the plurality of fan blades is always different than any other of the plurality of fan blades during operation.

In a further embodiment of any of the foregoing gas turbine engines, including a flow surface forward of the fan nacelle for a portion of the circumference of the fan assembly.

In a further embodiment of any of the foregoing gas turbine engines, an angle of pitch of one of the plurality of fan blades at a circumferential position within the portion of the circumference of the fan assembly including the flow surface forward of the fan nacelle is greater than an angle of pitch for ones of the plurality of fan blades outside the circumferential position.

In a further embodiment of any of the foregoing gas turbine engines, the angle of pitch for each of the plurality of fan blades cycles between a first angle of pitch that is greater than a second angle of incidence for each rotation about the fan rotational axis.

In a further embodiment of any of the foregoing gas turbine engines, the pitch mechanism comprises a swashplate coupled to pivoting mechanisms coupled to each of the plurality of fan blades.

In a further embodiment of any of the foregoing gas turbine engines, the pitch mechanism comprises a plurality of electric motors coupled to a pivoting mechanism coupled to each of the plurality of fan blades.

In a further embodiment of any of the foregoing gas turbine engines, the pitch change mechanism can change the pitch of the plurality of fan blades to a uniform negative value to produce reverse thrust.

Another gas turbine engine according to an exemplary embodiment of this disclosure includes, among other possible things, a fan section including a plurality of fan blades rotatable about an axis of rotation, a fan nacelle surrounding a portion of the plurality of fan blades, and a pitch mechanism coupled to each of the plurality of fan blades that changes a pitch angle for each of the plurality of fan blades individually corresponding to ingested airflow velocity corresponding to a circumferential region of fan section.

In a further embodiment of the foregoing gas turbine engine, the pitch angle for each of the plurality of fan blades is increased for regions of lower airflow velocities and decreased for regions of increased airflow velocities.

In a further embodiment of any of the foregoing gas turbine engines, a surface forward of the fan nacelle corresponding with a region of the lower airflow velocities is included, and the pitch mechanism increases a pitch angle of one of the plurality of fan blades entering the first portion of the circumferential region.

In a further embodiment of any of the foregoing gas turbine engines, the pitch mechanism comprises a swashplate coupled to pivoting mechanism for each of the plurality of fan blades.

In a further embodiment of any of the foregoing gas turbine engines, the pitch mechanism comprises a plurality of electric motors coupled to a pivoting mechanism coupled to each of the plurality of fan blades.

A method of operating a gas turbine engine mounted within an aircraft fuselage according to an exemplary embodiment of this disclosure includes, among other possible things, changing a pitch angle for each of a plurality of fan blades rotating into a low airflow velocity region during rotation about a rotational axis and changing the pitch angle for each of the plurality of fan blades rotating into a higher airflow velocity region during rotation about rotational axis.

In a further embodiment of the foregoing method of operating a gas turbine engine mounted within an aircraft fuselage, the low airflow velocity region comprises a boundary layer airflow ingested into the fan within a partial circumferential region.

In a further embodiment of any of the foregoing methods of operating a gas turbine engine mounted within an aircraft fuselage, a pitch mechanism automatically changes the pitch angle to correspond within a circumferential region of the fan.

In a further embodiment of any of the foregoing methods of operating a gas turbine engine mounted within an aircraft fuselage, a pitch mechanism automatically changes the pitch angle to correspond with a detected airflow velocity within a circumferential region of the fan.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example aircraft.

FIG. 2 is a schematic view of a portion of the example aircraft and an example propulsion system.

FIG. 3 is a schematic representation of an incoming airflow velocities.

FIG. 4 is a schematic view of fan blade pitch and incidence angle.

FIG. 5 is a schematic view of another fan blade pitch and incidence angle.

FIG. 6 is a schematic cross-section of an example fan assembly.

FIG. 7 is a graph illustrating fan pitch angle relative to a circumferential position.

FIG. 8 is a schematic cross-section of another example fan assembly.

### DETAILED DESCRIPTION

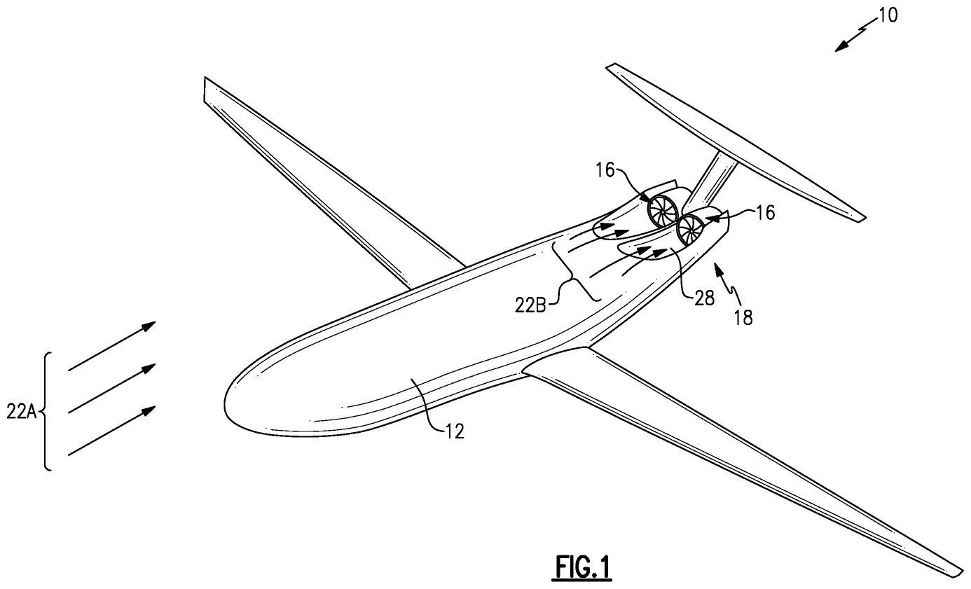

Referring to the FIG. 1, an aircraft 10 includes a fuselage 12 and a propulsion system 18 mounted within an aft end of the fuselage 12. The example propulsion system 18 includes first and second gas turbine engines (not shown) that drive corresponding fan assemblies 16.

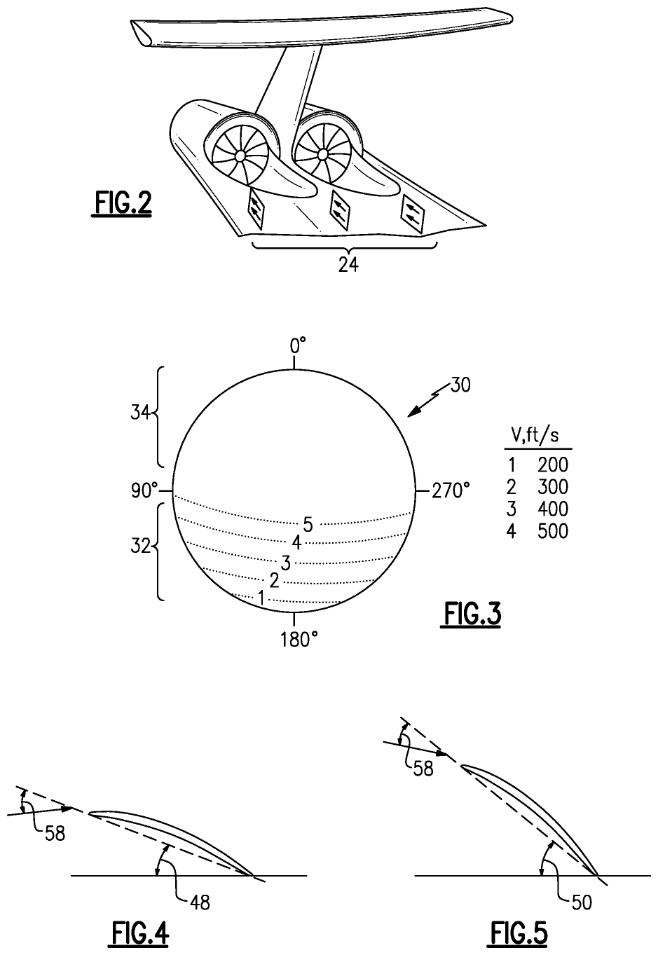

Referring to FIG. 2 with continued reference to FIG. 1, the propulsion system ingests airflow 22B within each fan assembly 16. Because the propulsion system 18 is mounted within and at the aft end of, the fuselage 12, the fan assemblies 16 ingest boundary layer airflow schematically shown at 24. Each fan assembly 16 is partially surrounded by a nacelle 26. A portion of the fan assembly 16 not surrounded by the nacelle 26 is disposed aft of a surface 28 of the fuselage 12. Due to boundary layer development along fuselage 12 and surface 28 airflow along and above surface 28 includes varying airflow velocity 24 that is less than airflow velocity 22A which is equal to aircraft speed. This varying airflow velocity creates a non-uniform flow-field entering the fan assembly 16 that results in non-optimal incidence angles for at least some of the fan blades 20. Conventional jet engine fans are designed to receive uniform flow, as in 22A.

The pitch angle for each fan blade 20 is conventionally the same for fan assemblies 16 not subject to non-uniform airflow velocities. As appreciated, in a conventional nacelle mounted engine, the flow field is substantially uniform and therefore a single blade pitch angle for each fan blade can be utilized and optimized.

Referring to FIGS. 3, with continued reference to FIG. 2, a representation of airflow velocities within the circumference of the fan assembly 16 is indicated at 30 and relates airflow to an angular position within the circumference of the fan 16. The example fan assemblies 16 are mounted adjacent to surfaces of the fuselage 12 and therefore encounter non-uniform airflow velocities that vary within a circumferential region of the fan inlet area. The airflow velocities vary in a way corresponding with proximity to the distance from the surface 28 of the fuselage 12. The closer to the surface 28, the slower the airflow. The further away from the surface 28, the higher the airflow velocity. The non-uniform airflow velocities create different regions including a lower velocity region schematically shown at 32 and a higher velocity region 34. The differences in inlet airflow velocities result in differing output velocities of airflow.

The example disclosed fan assembly 16 includes a mechanism to adjust the pitch of each fan blade 20 depending on a circumferential position in order to provide the proper blade pitch corresponding to the incoming airflow velocity vector. The incoming airflow velocity vector is the resultant vector of the blade rotation and airflow speed. The resulting outlet airflow field then becomes more uniform and efficient. The fan will also see less mechanical stress and vibration.

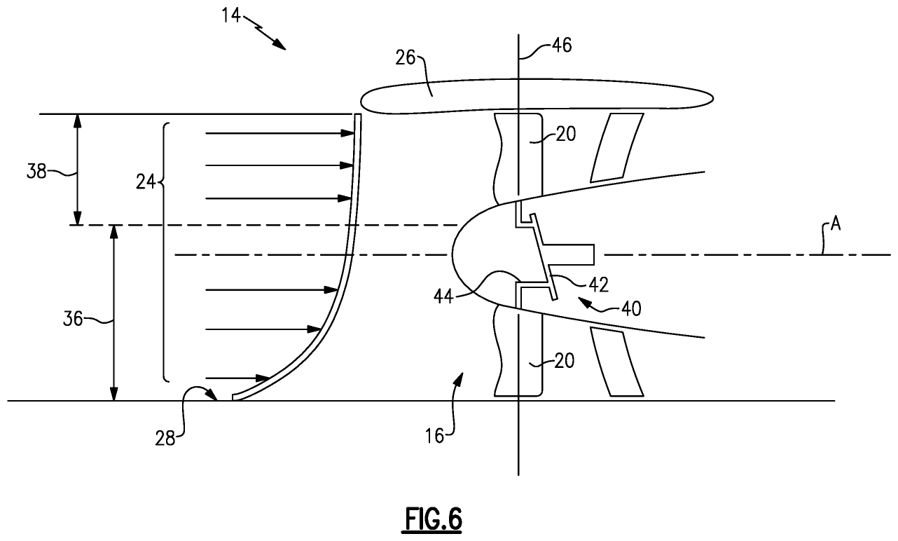

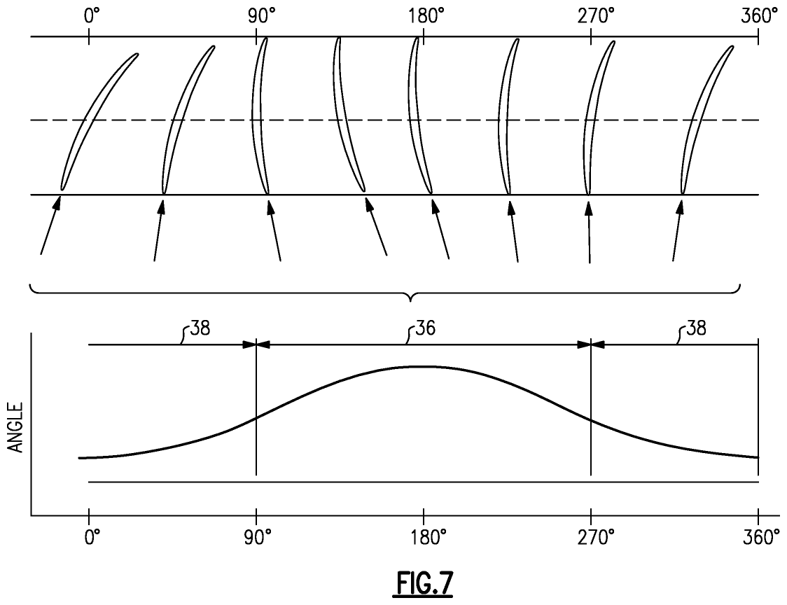

Referring to FIGS. 4 and 5 with continued reference to FIG. 3, each blade 20 is moved from a lower pitch angle 48 (FIG. 4) to a higher pitch angle 50 (FIG. 5) depending on the incoming airflow incidence 58. Airflow at higher velocities and higher incidence angle 58 such as those shown in region 34 in FIG. 3 do not require the fan blades to perform as much work as those within the region 32 of lower airflow velocities in order to obtain a uniform output flow. In other words, the higher pitch angle 50 performs more work to generate the exhaust flow than that of the lower pitch angle 48. However, the lower pitch angle 48 is provided in regions 34 with higher incoming airflow velocity such that overall airflow exiting the fan assembly 16 to provide the desired thrust is more uniform about the circumferences of the fan assembly 16. The change in pitch angle also optimized blade incidence angle 58a-b which maximizes fan efficiency.

Referring to FIG. 6, the disclosed fan assembly 16 includes a plurality of the fan blades 20 that rotate about the fan rotation axis A. Each of the plurality of fan blades 20 are also rotatable about an axis 46 transverse to the axis A to adjust a pitch angle. The pitch angle is automatically adjusted depending on a circumferential position of the fan blade 20 to accommodate the varying airflow incidence angles.

The disclosed fan assembly 16 includes a pitch change mechanism 40 that includes a swashplate 42 that is coupled to pivot mechanism 44 for each of the plurality of fan blades 20. The swashplate 42 moves each of the fan blades 20 to adjust a pitch angle as it rotates about the axis A. The pitch angle is increased as each blade 20 moves into the boundary layer region schematically shown at 36 and decreased as the blade 20 moves back into the region 38 that is not subject reduced airflow velocities and boundary layer airflow influence.

The swashplate 42 is a mechanical means of automatically changing the pitch angle for each of the plurality of fan blades separately during rotation about the axis A. No further control or adjustment is provided. Instead, the swashplate sets a defined pitch angle for each circumferential position about the axis A.

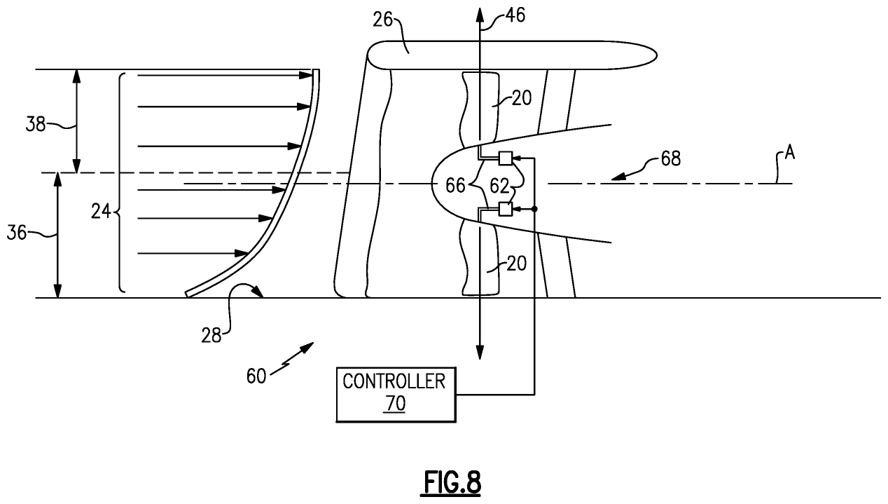

Referring to FIG. 7 with continued reference to FIG. 6, variation of the pitch angle 52 at a circumferential position 54 is illustrated in graph 56. The pitch angle 52 varies for each of the plurality of fan blades 20 depending on a circumferential position of each specific fan blade 20. For example, a fan blade 20 at the top center position indicated as the 0 degree position in graph 56 will have a first pitch angle. A fan blade 20 at or near the bottom position indicated as 180 degrees will have a second different and higher pitch angle. The circumferential position 54 of each of the fan blades 20 corresponds with the regions of higher and lower airflow velocities. For example, the boundary layer region 36 includes airflows of lower velocities and correspond with higher pitch angles 52. The other regions away from the boundary layer as shown at 38 correspond with lower pitch angles 52.

Accordingly, the fan blades 20 each cycle through the different pitch angles for each of the different circumferential positions about the axis A. The variations in pitch angles match each fan blade to the incoming airflow velocities to provide a uniform blade incidence angle, and thus a higher fan efficiency and more uniform exhaust flow.

Referring to FIG. 8, another example fan assembly 60 is shown and includes motors 62 that are controllable to drive a pitch mechanism 66 coupled to each of the fan blades 20 for rotating the blades about the axis 46 to adjust a pitch angle. In this example the motors 62 are electric motors, but other motors as are known could be utilized and are within the contemplation of this disclosure. The pitch angle is adjusted depending on the incoming airflow velocities corresponding to a circumferential position. The blade pitch is adjusted accordingly based on the circumferential position to provide a more uniform exhaust airflow.

It should be understood, that although example pitch mechanism have been disclosed and described by way of example, that other control systems and mechanisms for adjusting the pitch angle of each fan blade based on a circumferential positon could be utilized and are within the contemplation of this disclosure.

Accordingly, the example fan assembly includes features for adjusting a fan blade pitch angle to correspond with a non-uniform incoming airflow velocity field to increase fan efficiency and provide a more uniform exhaust flow.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A fan assembly for gas turbine engine comprising;
a plurality of fan blades rotatable about a fan rotation axis, each of the plurality of fan blades movable about an axis transverse to the fan rotation axis;
a fan nacelle partially surrounding the plurality of fan blades;
a pitch mechanism coupled to the plurality of blades that changes an angle of pitch for each of the plurality of blades corresponding to a circumferential position of the fan blade about the fan rotation axis.

2. The fan assembly as recited in claim 1, wherein the pitch mechanism changes an angle of pitch automatically for each of the plurality of fan blades at the corresponding circumferential position.

3. The fan assembly as recited in claim 2, wherein an angle of pitch for at least two of the plurality of fan blades is always different than any other of the plurality of fan blades during operation.

4. The fan assembly as recited in claim 2, including a flow surface forward of the fan nacelle for a portion of the circumference of the fan assembly.

5. The fan assembly as recited in claim 4, wherein an angle of pitch of one of the plurality of fan blades at a circumferential position within the portion of the circumference of the fan assembly including the flow surface forward of the fan nacelle is greater than an angle of pitch for ones of the plurality of fan blades outside the circumferential position.

6. The fan assembly as recited in claim 1, wherein the angle of pitch for each of the plurality of fan blades cycles between a first angle of pitch that is greater than a second angle of incidence for each rotation about the fan rotational axis.

7. The fan assembly as recited in claim 1, wherein the pitch mechanism comprises a swashplate coupled to pivoting mechanisms coupled to each of the plurality of fan blades.

8. The fan assembly as recited in claim 1, wherein the pitch mechanism comprises a plurality of electric motors coupled to a pivoting mechanism coupled to each of the plurality of fan blades.

9. The fan assembly as recited in claim 1, wherein the pitch change mechanism can change the pitch of the plurality of fan blades to a uniform negative value to produce reverse thrust.

10. A gas turbine engine comprising:
a fan section including a plurality of fan blades rotatable about an axis of rotation;
a fan nacelle surrounding a portion of the plurality of fan blades;
a pitch mechanism coupled to each of the plurality of fan blades that changes a pitch angle for each of the plurality of fan blades individually corresponding to ingested airflow velocity corresponding to a circumferential region of fan section.

11. The gas turbine engine as recited in claim 10, wherein the pitch angle for each of the plurality of fan blades is increased for regions of lower airflow velocities and decreased for regions of increased airflow velocities.

12. The gas turbine engine as recited in claim 11, including a surface forward of the fan nacelle corresponding with a region of the lower airflow velocities and the pitch mechanism increases a pitch angle of one of the plurality of fan blades entering the first portion of the circumferential region.

13. The gas turbine engine as recited in claim 10, wherein the pitch mechanism comprises a swashplate coupled to pivoting mechanism for each of the plurality of fan blades.

14. The gas turbine engine as recited in claim 10, wherein the pitch mechanism comprises a plurality of electric motors coupled to a pivoting mechanism coupled to each of the plurality of fan blades.

15. A method of operating a gas turbine engine mounted within an aircraft fuselage, the method comprising:
changing a pitch angle for each of a plurality of fan blades rotating into a low airflow velocity region during rotation about a rotational axis; and
changing the pitch angle for each of the plurality of fan blades rotating into a higher airflow velocity region during rotation about rotational axis.

16. The method as recited in claim 15, wherein the low airflow velocity region comprises a boundary layer airflow ingested into the fan within a partial circumferential region.

17. The method as recited in claim 15, wherein a pitch mechanism automatically changes the pitch angle to correspond within a circumferential region of the fan.

18. The method as recited in claim 15, wherein a pitch mechanism automatically changes the pitch angle to correspond with a detected airflow velocity within a circumferential region of the fan.
